(19) United States
(12) Patent Application Publication
(10) Pub. No.: US 2024/0241210 A1
(43) Pub. Date: Jul. 18, 2024

(54) METHOD AND SYSTEM FOR DETERMINING THE LOCATION OF SHELVING-RAIL EQUIPMENT

(71) Applicant: VusionGroup GmbH, Fernitz-Mellach (AT)

(72) Inventors: Andreas RÖSSL, Fernitz-Mellach (AT); Philipp Jauck, Fernitz-Mellach (AT)

(73) Assignee: VusionGroup GmbH, Fernitz-Mellach (AT)

(21) Appl. No.: 18/559,053

(22) PCT Filed: May 5, 2021
(86) PCT No.: PCT/EP2021/061909

§ 371 Date: Nov. 5, 2023

(51) Int. Cl. G01S 5/02; G06K 7/10; G06V 10/94; G06V 20/70

(52) U.S. Cl. CPC G01S 5/0269; G06K 7/10366; G06V 10/95; G06V 20/70

(57) ABSTRACT

Method for locating shelving-rail equipment positioned on a shelving-rail at an unknown location, wherein the method comprises the following method steps, namely: automatically determining a location of the shelving-rail equipment on a level by means of radio communication between the shelving-rail equipment and locally known radio devices, and automatically adding a third coordinate to the location on the level for the purpose of determining the spatial location of the shelving-rail equipment through the use of supplementary data, wherein the supplementary data represent the third coordinate and are related to the shelving-rail equipment.

### TECHNICAL FIELD

The invention relates to a method and a system for locating shelving-rail equipment.

### Background

A method for locating radio tags is known from PCT/EP2014/059824, wherein, in a group of radio tags, in particular, designed as electronic price display devices, a locating signal a) is either emitted by one or a plurality of position-known radio tags and is received by the position-unknown radio tag, b) or is emitted by the position-unknown radio tag and is received by one or a plurality of position-known radio tags, and in both cases a), b), in the case of the radio tag receiving the locating signal, the reception quality for the locating signal is determined and provided as a basis for narrowing down the position of the position-unknown radio tag.

This method has proven to be very favourable in practice to find individual missing radio tags. In this application, it is less important to locate the exact spatial position. Rather, it is sufficient if the position of the radio tag at an unknown location can at least be narrowed down in order to then search manually in this limitation area and also find the radio tag at an unknown location there. However, if this method were to be used to systematically determine the position of all radio tags, this would be accompanied by an unjustifiably high energy consumption of the individual radio tags and the result would only be available after a relatively long processing time, which would drastically shorten the service life of the batteries, particularly with battery-operated radio tags. The resulting maintenance effort is disproportionate to the benefits.

The object of the invention is to provide an improved method.

### SUMMARY OF THE INVENTION

This object is achieved by means of a method for locating shelving-rail equipment at an unknown location according to Claim 1. The object of the invention is therefore a method for locating shelving-rail equipment positioned on a shelving rail at an unknown location, wherein the method comprises the following method steps, namely automatically determining a location of the shelving-rail equipment on a level by means of radio communication between the shelving-rail equipment and locally known radio devices and automatically adding a third coordinate to the location on the level for the purpose of determination of the spatial location of the shelving-rail equipment by using supplementary data, wherein the supplementary data represent the third coordinate and are related to the shelving-rail equipment.

The measures according to the invention are accompanied by the advantage that the localization of a shelving-rail equipment attached to a shelving rail (particularly electronic) is much more precise, significantly faster and with considerably less collective energy consumption. This is achieved by splitting the definition of the spatial coordinates into two sub-processes.

As a first sub-process, a tried and tested and widely used radio-based localization is used, with the help of which a reliable determination of the location on one level, preferably on the horizontal level, takes place. This has proven to be particularly useful for indoor positioning, particularly in the sales rooms of retailers or supermarkets, because such premises often comprise a large area and a relatively low spatial height in comparison. In these rooms, radio devices for radio-based positioning of the shelving-rail equipment can be excellently positioned, e.g., on the ceiling at optimal distances or positions from each other. Accordingly, the positioning process for the shelving-rail equipment on one level (e.g., projected on the level of the ceiling or also parallel to the ceiling where the radio devices are positioned) provides results with excellent accuracy.

However, the situation is different with the third coordinate (z-coordinate), which, in addition to the other two coordinates (x and y coordinates), which indicate the location on the level, is necessary to determine the spatial point at which the shelving-rail equipment in question is located. Experience has shown that radio-based methods do not provide the necessary accuracy in the z-direction. This can be due to an unfavourable relationship between the area and the spatial height of the sales room as well as to a wide variety of circumstances in the sales rooms that prevent optimal radio propagation (shading, reflection, interference signals from other radio systems, etc.). Also, the (horizontal) distances in the third coordinate between adjacent shelving-rail equipment are often relatively small, which exacerbates the problem of inaccuracies in the radio-based determination of the third coordinate.

In order to overcome this problem of radio-based methods, according to the invention, the second sub-measure, namely the supplementation of the radio-based determination of the coordinates of the level by automatic inclusion of the supplementary data, comes into play here. Thus, radio-based positioning is not completely dispensed with, but rather radio-based technology is used for that area of automated positioning (this is the determination of location on the levels) for which it delivers results with acceptable accuracy under the given framework or operating conditions.

Thereby, the weak point (spatial resolution in the third coordinate; z-coordinate) of the fully automatic radio-based localization of the shelving-rail equipment is overcome by automatic inclusion of the supplementary data for locating the shelving-rail equipment in the third coordinate. Thus, the two coordinates of the level obtained on a radio basis are supplemented by a third coordinate obtained in a different way.

In this context, the fact that the supplementary data is related to the shelving-rail equipment means that a certain third coordinate is provided for a certain shelving-rail equipment by the supplementary data. This relationship can be given by a unique identifier of the affected shelving-rail equipment, with which identifier the third coordinate is also “married”.

However, this third coordinate to be added can also be assigned to a group of shelving-rail equipment if it is valid for all members of this group, i.e., the members of this group all comprise this specific third coordinate in their spatial location.

Regardless of the fact that the first two coordinates are found for localization on the level by radio communication, the determination of the third coordinate is based on a different method than the mentioned radio communication, in particular, not on radio communication. The third coordinate is thus determined by means of a method that differs from the method used to determine the other two coordinates and is then automatically used to supplement the coordinate pair of the level determined by radio communication to a spatial location indication with three coordinates.

In summary, this is a combination of extremely energy-saving measures for complete location determination or localization. Each of these sub-measures can be carried out quickly and without any problems and on its own provides correct partial results in a reliable and easily reproducible manner, which are automatically combined into an overall result for complete location determination.

In contrast to the swarm-based positioning method mentioned at the beginning, each piece of shelving-rail equipment must transmit in accordance with the method according to the invention only for the determination of its own location. In addition, a time-consuming and complex, also where applicable, long-lasting, radio traffic to determine the third coordinate, which is relatively difficult to determine as accurately as possible, is avoided by substituting radio communication for determining this third coordinate.

Furthermore, particularly favourable embodiments and further embodiments of the invention result from the dependent claims as well as the following description.

A shelving rail is usually understood to be the front end of a shelf floor of a shelf. Analogous to the arrangement and number of shelf floors, the shelving rails are also arranged on top of each other, i.e., along the spatial z-coordinates. The shelving rails usually run on a level that is normally orientated to the z-coordinate, and locations along the shelving rail are uniquely identifiable on this level by the x-coordinate and y-coordinate of a Cartesian coordinate system. The choice of the origin of this coordinate system is arbitrary and therefore a matter of convention.

It is to be understood that another coordinate system can also be used for the purpose of determining location, such as a cylindrical coordinate system, etc.

In the simplest case, the shelving-rail equipment can be a shelving-rail radio device (e.g., a radio transceiver) that is attached to the shelving rail in question or an integral, where applicable, also modularly removeable component of the shelving rail.

The shelving-rail equipment can also be formed by an electronic shelf label that comprises a corresponding radio module to communicate with shelf-label access points, e.g., to receive data for a display on its screen or also to transmit data, such as its battery status or display update status, across the shelf-label access point. However, the radio module can also be used for radio communication to determine the location.

In addition to the electronic shelf labels mentioned above, other electronic devices can also be used as shelving-rail equipment. These different devices can include basic functionality or basic embodiment without claiming to be exhaustively listed: Sensors such as temperature sensors or proximity sensors, etc.; cameras for still image or video recording or infrared recording; input devices such as individual keys or keypads or rotary knobs or knobs or also touch screens; display units such as one or a plurality of light-emitting diodes (LEDs), video screens or also electronic shelf displays with energy-saving bistable screen technologies such as electronic ink or e-paper or active screen technologies such as liquid crystal display (LCD) or organic light-emitting diodes (OLED), etc. So, the previously mentioned devices essentially comprise basic functionality. However, such devices can also comprise combined basic functionalities or provide a dominant basic functionality supplemented by other supporting functions. Thereby, these electronic devices can also provide additional, complementary communication functionalities, such as an NFC interface for device activation, for data transmission to and from the device or also controlling functions of the device from close proximity (a few millimetres to a few centimetres) or also for establishing a bond between a product and the electronic device or a Bluetooth low-energy radio module for radio communication over longer distances with compatible radio devices.

For example, in the case of radio communication for the purpose of determining the location on the level, an infrastructure of WLAN access points can be used as the shelf-label access points. With the aid of the WLAN access points, e.g., by triangulation, the coordinate pair for determining the equipment on the level can be determined.

However, for the automatic determination of the location on the level, it is preferable to use ultra-wideband-radio communication between locally known ultra-wideband-radio devices, in particular, access points equipped with them, which are positioned at different known locations at a distance from the shelving-rail equipment, and the shelving-rail equipment. Thus, the advantages of ultra-wideband-radio communication (abbreviated UWB-radio communication) can be fully exploited for the purposes of precise indoor positioning of the equipment on the level.

In doing so, well-known measures, such as “Two-way Ranging” (abbreviated TWR), “Time-difference-of-Arrival” (abbreviated TDoA) or also “Phase-Difference-of-Arrival” (abbreviated PDoA) can be used.

The UWB-radio devices can be individually designed and installed as locally known anchors for UWB-radio communication in a business premises, e.g., positioned on the ceiling of business premises. A wireless combination device consisting of a WLAN access point and a UWB-radio device can also be provided so that there is no additional installation effort for the UWB-radio devices, because a WLAN infrastructure is usually always desired and necessary. In this case, each radio combination device forms the locally known anchor for UWB-radio signal or communication-based location determination on the level.

It can also be provided in a shop that, for example, a specially designated shelving-rail equipment network with shelving-rail equipment access points is operated for the purpose of controlling the shelving-rail equipment. Simultaneously, the locally known UWB-radio devices can also be operated or installed. Also in this case, a wireless combination device consisting of a shelving-rail equipment access point and a UWB-radio device, where applicable, also in combination with a WLAN access point, can be implemented. Also in this case, each radio combination device forms the locally known anchor for UWB-radio signal or communication-based location determination on the level.

As mentioned, the automatic addition of the third coordinate is not based on a radio-based positioning method. Rather, the supplementary data can be obtained from a data structure that is stored in an electronic database. The third coordinate can represent a z-coordinate in the classical sense, e.g., given in metres or millimetres, etc. Preferably, the data structure, as the third coordinate, indicates at which shelf level of a shelf the relevant shelving-rail equipment is installed. The third coordinate does not necessarily represent a classic z-coordinate but refers to a unit defined by the shelf or its individual structure, such as the first, second, third, etc. shelf level or e.g., the lowest, middle and top shelf levels. Of course, corresponding to the number of the shelf levels, a classic length measure could also be stored in order to provide the physical third (z) coordinate in metres, etc.

The data structure is built up by capturing identification data of the shelving-rail equipment and assigning the identification data to the shelf level where the shelving-rail equipment is located. In this process, a logical link is created and stored in a digital way between a shelf-label equipment uniquely identified with the aid of the identification data and the shelf level at which it is installed.

The structure of the data structure can precede the radio-based determination of the two coordinates of the level. For example, the data structure can already be set up during the installation of the shelves or the shelving-rail equipment on the shelves. This also has the advantage that, as soon as the coordinate pairs of the level for a specific shelving-rail equipment have been determined in a radio-based manner, wherein the identification data of the respective shelving-rail equipment has also been recorded, the associated third coordinate can be included via the knowledge of the identification data and the spatial position, particularly in the planogram, can be directly assigned or assigned to the affected shelving-rail equipment can be.

If the structure of the data structure is upstream of the radio-based determination of the two coordinates of the level, the two coordinates of the level must first be intermediately saved until the corresponding third coordinate is available and can be used to supplement the two coordinates of the level.

In this case, for the purpose of assigning the identification data to the applicable shelf level, the identification data can be automatically read out by the shelving-rail equipment with the aid of a portable recording device and shelf-level data can be generated by receiving an input to determine the shelf level at the recording device and the identification data together with the shelf-level data can be transmitted to the electronic database, preferably with the aid of radio communication, and transmitted there can be saved.

Therefore, here, the identity of the relevant shelving-rail equipment is first determined. This can be done, for example, with the aid of a barcode or a QR code attached to the shelving-rail equipment, which is scanned with the portable recording device used by an employee of the retailer. However, this identification can also be done by detecting a flashing light signal, with the aid of which the identification data is encoded and which is emitted by the shelving-rail equipment. Identification can also be carried out with the aid of RFID (Radio Frequency Identification) or NFC (Near Field Communication) communication between the relevant shelving-rail equipment and the portable recording device.

The shelf level at which the relevant shelving-rail equipment is installed is recorded by input on the portable recording device by the employee, such as by pressing a touch screen or predefined buttons or by voice control, and thus determines from which the recording device generates the shelf-level data.

The identification data and shelf-level data obtained in this way are transmitted from the recording device to the database, where they are stored in association with each other as a related data pair.

As mentioned, identification can be carried out by detecting a light signal, wherein the portable detection device must essentially be aligned with the shelving-rail equipment in question and, where applicable, also held close to it by said employee.

However, the assignment to the shelf level can also be fully automated, wherein in order to assign the identification data to the applicable shelf level, the shelving-rail equipment emits an optically perceptible or machine-processable first signal and, with the aid of a camera, a digital image of the shelf on which the shelving-rail equipment in question is located is created and computerizes that shelf level in the digital image by recognizing the optical signal is identified where the shelving-rail equipment that emits the optical signal is located, and the shelf-level data generated from it is transmitted to the electronic database, preferably with the aid of radio communication, and stored there.

Particular preference can also be given to automated identification, wherein the shelving-rail equipment transmits its identification data with the aid of the optically perceptible or machine-processable first signal and the identification data is computerized extracted from the digital image and transmitted together with the shelf-level data.

The computerized processing of images of a scene captured with the aid of the camera in the form of still images as well as video sequences for the purpose of identifying image content or information content is carried out with the aid of a computer on which software programmed for this purpose is processed. The corresponding programming is part of the routine activity for a person skilled in the art in the field of computer-aided image processing.

For the purpose of image detection, a plurality of cameras with corresponding detection areas can be attached, e.g., to the ceiling of the sales premises, or also to other objects in the sales premises. These cameras can be connected to the aforementioned computer via cable, e.g., by means of Power-over-Ethernet, or also via radio, e.g., by means of WLAN, and deliver the captured images digitally to the computer where the image processing takes place.

However, in order to ensure that image capture is as unproblematic as possible, it has proven to be favourable if the shelves themselves are used for positioning. For example, the mechanical structure of the shelf itself, such as the beams or struts of the shelf, can be used to carry the camera. In this context, it has proven to be particularly favourable if the camera is installed on a shelving rail of a first shelf and the camera captures a second shelf across a shelf path on which the shelving-rail equipment is installed, which emits the optically perceptible or machine-processable signal. With this arrangement, the usual additional positioning or alignment considerations or also additional mechanical structures for attaching the cameras are completely eliminated. In particular, the shelving rail itself is used for direct attachment of the camera.

Shelves are usually aligned parallel to each other along shelf paths and are not mandatory, but often also of the same length. Cameras that are placed in different positions along the shelves can therefore easily be installed on both sides of the shelf path on the respective shelf and easily capture the opposite shelf. The good detection of the opposite shelf is also not impaired even if the shelf paths converge at an angle, for example, or are curved or wavy or circular (even on one side).

The cameras can comprise an (auto-)focus and zoom function and include a controlled (motor-orientated) lens so that the detection area can be adjusted automatically, particularly computer-controlled.

As mentioned, the shelving-rail equipment can be implemented in a variety of ways and therefore, a plurality of such shelving-rail equipment can also be installed on the same shelving rail. However, it has proven to be particularly favourable if the shelving-rail equipment is a shelving-rail controller that supplies at least one shelving-rail client installed on its shelving rail with electrical power, preferably also in terms of communication, and the location of the shelving-rail controller is used to narrow down the location of the shelving-rail clients to the known extent of the shelving rail.

In this case, the shelving rail (and of course also the shelving-rail clients and the shelving-rail controller) can be designed to supply the shelving-rail clients with power in a contactless or also a contact-based manner.

The contactless power supply to the shelving rail can be implemented, for example, by integrating NFC communication modules into the shelving-rail clients and by integrating a conductor loop configuration in the shelving rail, wherein the shelving-rail controller is designed as an NFC reader to provide the power supply and the communication supply.

For the contact power supply to the shelving rail, electrical cables can be incorporated into the shelving rail, which run along the longitudinal extension of the shelving rail and can be contacted there. The shelving-rail controller and shelving-rail clients comprise contacts to contact these lines. An electronic communication module in each of the controller and the clients enables data exchange as well as an electrical supply via these lines.

In both cases, i.e., in the case of both contactless as well as contact-based power supply to the shelving rail, the shelving-rail controllers can be integrated in a wired manner, e.g., via LAN, or radio, into a communication network of the retailer and thus be in contact with a central, local server or with cloud-based management software for the purpose of managing the respective equipment.

In the case of radio-based connectivity, an essentially standardized communication method or protocol, such as WLAN, ZigBee, Bluetooth, etc., can be used. Of course, a proprietary communication method or communication protocol can also be used for the radio-based connection, as is known, for example, from PCT/EP2014/053376, wherein its disclosure is included by reference with regard to the time-slot communication method described therein. However, in contrast to the system disclosed in PCT/EP2014/053376, this time-slot communication method is used here for communication between a shelving-rail controller access point and a group of shelving-rail controllers assigned to this shelving-rail controller access point. The shelving-rail clients, such as so-called electronic shelf labels or also other electronic devices mentioned above, can use a completely different communication protocol or method for communication with the shelving-rail controller on the shelving rail.

Since the system knows which shelving-rail controller supplies which shelving-rail clients on its shelving rail, it is actually sufficient to carry out the location determination only for the respective shelving-rail controller in order to simultaneously know according to the geometry or dimensions of the relevant shelving rail where in something, i.e., limited to the respective shelving rail, the shelving-rail clients belonging to the located shelving-rail controller are located.

This group-by-group determination of the location of the shelving-rail controller, on the one hand, and also its shelving-rail clients, on the other hand, brings a significant improvement in the energy balance, because only a single device per shelving rail, namely the shelving-rail controller, can be used to carry out the location discussed, which leads to an electrical power requirement for this location activity in the case of the shelving-rail controller.

The automatic, computerized derivation of the position of the other shelving-rail clients, limited to the known extension of the shelving rail, is carried out for these shelving-rail clients without any power requirement for them. This means that the total energy requirement is reduced proportionately globally, i.e., system-wide. This is also favourable because the individual power requirements of the shelving-rail clients are either covered by their own energy spokes, such as a battery or a rechargeable battery, or must be covered by the energy store of the shelving-rail controller. The temporal availability of these energy store devices is thus extended, or, in other words, the frequency of their maintenance is reduced in the sense of replacement or recharging. Even with a wired power supply of the shelving-rail controller, the discussed improvement of the energy balance occurs, because here as well, simply fewer communication activities are required to locate the components of the system.

In order to obtain a more precise location for the individual shelving-rail clients on a shelving rail, it can be planned that a digital image of the relevant shelving rail is created with the aid of a camera(s) already mentioned and that the location of the shelving-rail client along the relevant shelving rail is determined by computerized image evaluation. Based on the appearance of the individual shelving-rail client, it is even possible to draw conclusions about its identity in a computerized manner. For example, the image content of the screen of the shelving-rail client can be evaluated in order to identify the shelving-rail client, because this screen content is basically known to the computer controlling the system. If there is no screen, other characteristic features of the outer shell of the respective shelving-rail client can be used to assign it to at least one equipment class.

Regardless of whether the affected shelving-rail client comprises a screen or not, it has proven to be particularly favourable if the shelving-rail client transmits its identification data with the aid of an optically perceptible or machine-processable second signal emitted by it and the identification data is extracted during the computerized image evaluation and the location of the relevant shelving-rail client along the shelving rail is determined becomes. It is therefore sufficient if, for example, a small light-emitting diode is provided, which, for example, emits a light signal at the front of the shelving-rail client, preferably a modulated light signal (pulse code modulated, brightness or intensity modulated, or also mixed, or also colour-characteristically modulated), which is used for identification, where applicable, also for locating the shelving-rail client on the shelving rail in question.

As mentioned at the beginning, radio communication can also be used to determine the third coordinate, wherein, however, the method used to determine the third coordinate is different from that used to determine the two coordinates on the level. For example, the distance between the shelf levels can be determined with the aid of time-of-flight measurements by time-of-flight sensors and/or the shelves can be sorted, i.e., assigned to the appropriate control level, e.g., by determining the signal strength of a radio signal along the third coordinate.

In summary, it should be noted that the measures described can be used to create a highly precise planogram, which forms a visual illustration of an item placement on shelves in a digital way. In any case, for the purpose of generating and maintaining a planogram, the third coordinate has proven to be extremely favourable as a direct illustration or indication of the applicable shelf levels. In this planogram, all shelving-rail equipment as well as the shelving rails themselves and, where applicable, also other objects attached to the shelving rails can now be reproduced exactly spatially.

In accordance with another aspect, the plurality of shelving-rail controllers attached to or positioned on the shelving rails, the respective positions of which have been determined or otherwise determined as discussed, can also be designed to emit beacons. In general, a beacon is to be understood as a radio signal that marks a fixed location, i.e., in this specific case the respective location of the emitting control rail controller, and that it can be used by another (in particular, portable or essentially freely moveable) radio equipment (e.g., a radio direction finding system, wherein its radio signal receiver is, e.g., implemented by a customer's mobile phone or can also be attached to a customer's shopping trolley or can be integrated there) allows you to find a relative bearing, such as the direction and/or distance, to the respective emitting shelving-rail controller.

This radio signal can transmit its own identifier that uniquely identifies it or the identifier of the respective shelving-rail controller, wherein with the aid of the identifier on the radio equipment or downstream, it can be determined which of the shelving-rail controller it is in each case and thereby, its position can also be called up. However, this radio signal can also transmit the position of the respective shelving-rail controller as such so that this position is immediately available to the radio equipment. The radio equipment provides a plurality of bearing results based on the beacons received.

Due to the plurality of shelving-rail controllers positioned relatively close to each other, a relatively plurality of beacons are also available at the respective location of the radio equipment. The bearing results obtained from this can be forwarded wirelessly to a central server, where they can be processed or evaluated in a variety of ways, e.g., to determine (the temporal and/or local component) customer flows or also dwell times in front of the shelves.

Due to the relatively high local density of the beacons at the respective location of the radio equipment, its location in relation to the locally known shelving-rail controllers can be determined with a maximum inaccuracy of approx. 20 cm. This not only allows the detection of presence in the vicinity of a shelf, as is the case with conventional systems, but also the relatively accurate determination of the location along the shelf, where applicable, with the appropriate mobility of the radio equipment along the height of the shelf also the location along this coordinate. In the event that the wireless equipment is installed in a device that follows the wearer's hand movement, such as a smart watch (e.g., an Apple Watch© or similar device) or a personal digital assistant worn on the hand, it can even be automatically recorded where the hand is moved on the shelf, i.e., on which tier the hand reaches into, if applicable, also where products are touched on the respective tier or from where products are removed from the respective tier.

The plurality of shelving-rail controllers that emit their beacons thus form a network of locally known radio beacons with a relatively high density, i.e., the basic algae for a radio direction finding system, with the aid of which it is even possible to determine the location of portable radio equipment down to the tiers of a shelf. The high density of the shelving-rail controllers also makes it possible to keep the transmission power for sending out the beacons relatively low and still have a sufficient number of beacons available for direction finding purposes and ultimately the location of the radio equipment at any location between the shelves for the radio equipment.

These and other aspects of the invention result from the figures discussed below.

### BRIEF DESCRIPTION OF THE FIGURES

The invention is explained in more detail below with reference to the attached figures on the basis of exemplary embodiments, to which, however, the invention is not limited. Thereby, identical components in the various figures are provided with identical reference numbers. The figures schematically show:

FIG. 1 a shelving arrangement in a shop with shelves of different lengths seen from the ceiling to the floor of the shop;

FIG. 2 the shelf arrangement viewed from the side along the longitudinal extension of the shelves;

FIG. 3 a path delimited by two shelves for the purpose of demonstrating a second exemplary embodiment;

FIG. 4 the path for the purpose of demonstrating a third exemplary embodiment.

### DESCRIPTION OF THE EXEMPLARY EMBODIMENTS

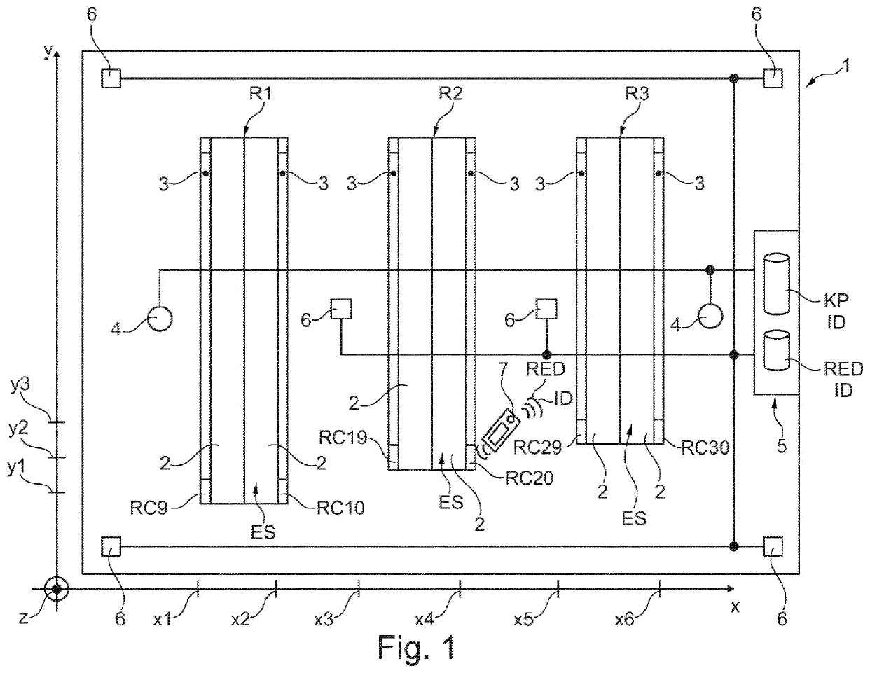

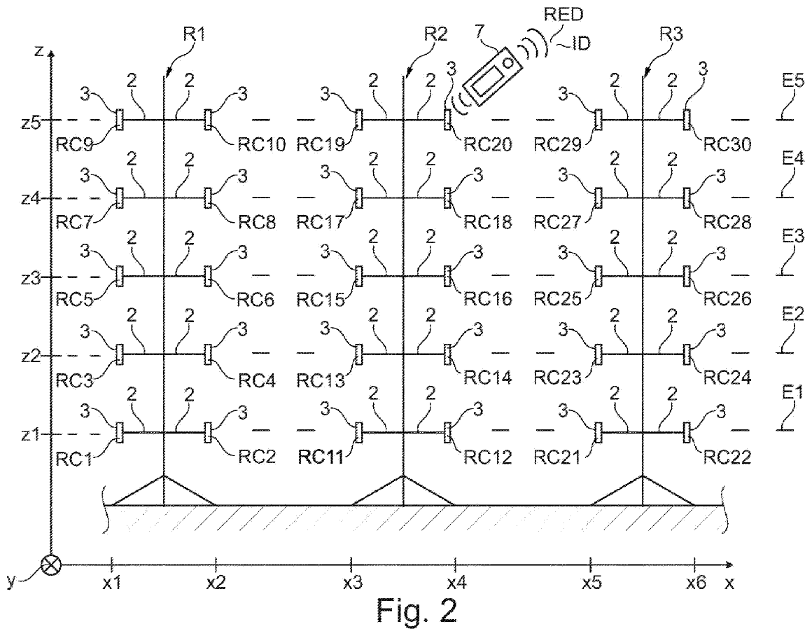

FIG. 1 shows a ground layout of a shop 1 in which three shelves R1, R2, R3 are arranged. Each of the shelves R1, R2, R3 comprises an individual length. All shelves R1-R3 comprise an identical height and width. A lateral view of these shelves can be seen in FIG. 2.

Each shelf R1-R3 comprises five (shelf floors or) shelf levels E1-E5 arranged on top of each other, wherein only the uppermost, fifth level E5 is visible in the selected view. In the present case, all shelves R1-R3 comprise the shelf levels E1-E5 at the same level per level. Of course, this can also be designed differently.

The shelf levels E1-E5 comprise a shelf floor 2 on the left and right sides so that a total of thirty shelf floors 2 are provided. Each shelf floor 2 is closed on the outside with a shelving rail 3, which carries a shelving-rail controller RC1-RC30 as a piece of shelving-rail equipment, which is designed and provided to supply shelving-rail clients (not shown) installed or attached to the respective shelving rail 3. In the selected view, of the thirty shelving-rail controllers RC1-RC30, only those of the fifth level E5 with the reference numbers RC9, RC10, RC19, RC20, RC29 and EC30 can be seen.

Furthermore, two shelving-rail-equipment access points 4, abbreviated to access point 4, are installed on the ceiling in the shop 1, which are designed and provided for the radio supply of the shelving-rail controllers RC1-RC30 using the proprietary time-slot communication method listed in the general description. They are connected in a wired manner via LAN cabling to a server 5 of shop 1, where management software is run to manage the shelving-rail equipment and goods logistics. To straightforwardly facilitate illustration, the mapping of other network components that are usually used, such as switches, etc., has been dispensed with. With the aid of server 5, the shelving-rail clients attached to the respective shelving rails 3 can be supplied with data or retrieved from there via access points 4, each of which is assigned a group of shelving-rail controllers RC1-RC30, and via the shelving-rail controllers RC1-RC30. In the case of electronic shelf labels as shelving-rail clients, the image content of the individual screens can be defined, and status information can be retrieved from the shelf labels.

Furthermore, six UWB-radio devices 6 are installed in the shop 1 distributed on its ceiling, the locations of which are known to the server 5. In the present case, they are also connected to the server 5 of the shop by means of wired LAN cabling. However, you can also be wirelessly connected to this server 5.

The shelving-rail controllers RC1-RC 30 each comprise two radio modules (not shown in detail), wherein the first radio module is designed and intended for radio communication with the access points 4 and the second radio module is designed and intended for radio communication with the UWB-radio devices 6.

With the aid of the UWB-radio communication between the UWB-radio devices 6 and the shelving-rail controllers RC1-RC30, the position of the shelving-rail controllers RC1-RC30 in the shop 1 is determined, but with the restriction that only two coordinates of the level, i.e., the x-coordinate and the y-coordinate of the Cartesian coordinate system shown in FIG. 1, are evaluated. This process is carried out fully automatically under the control of server 5, which controls the shelving-rail controllers RC1-RC30 as well as the UWB-radio devices 6 in such a way that they carry out the UWB-radio communications necessary for location determination in a well-known manner and deliver the data obtained to the server 5 for furthermore processing and localization of the shelving-rail controllers RC1-RC30 in the X-Y level.

In the synopsis of FIGS. 1 and 2, this results in a coordinate pair KP for the controllers RC1-RC 30 with an indication of the respective X and Y coordinates in the notation (Xi, Yi):
RC1, RC3, RC5, RC7, RC9 each a pair of coordinates (X1, Y1),
RC2, RC4, RC6, RC8, RC10 each a pair of coordinates (X2, Y1),
RC11, RC13, RC15, RC17, RC19 each a pair of coordinates (X3, Y2),
RC12, RC14, RC16, RC18, RC20 each a pair of coordinates (X4, Y2),
RC21, RC23, RC25, RC27, RC29 each a pair of coordinates (X5, Y3) and
RC22, RC24, RC26, RC28, RC30 each a pair of coordinates (X6, Y3).

The numerical values of the actually identical X or Y coordinates determined in this way can of course show slight fluctuations or deviations from each other, but this does not change their sufficient accuracy and significance, which is necessary for locating the controllers RC1-RC 30 on the level and is achieved with the aid of UWB-radio communication.

Server 5 stores the coordinate pairs (Xi, Yi) of the level determined in this way for each controller RC1-RC30 together with the respective identification data ID of the respective controller RC1-RC30. At a further step, the coordinate pairs (Xi, Yi) are extended or supplemented by the third coordinate, which is necessary for spatial localization.

In the case of server 5, this is done by automatically incorporating supplementary data stored in a data structure on server 5 that was previously created.

In accordance with a first exemplary embodiment, the data structure was built up with the aid of a portable detection device 7. This can be a personal digital assistant (PDA). This PDA 7 is operated by an employee of shop 1 and is used, among other things, to create a logical binding of products (not shown) with electronic labels that are attached to a shelving rail 3 where the product in question is located.

In the present context, however, the PDA 7 is also used to determine the shelf level E1 E2, E3, E4 or E5 for the respective shelving-rail controller RC1-RC30. The PDA 7, which is NFC-enabled, is held close to the respective shelving-rail controller RC1-RC30, which is also NFC-enabled, and the respective identification data ID is obtained from it. Then the shelf level is selected on the touch screen of the PDA 7 to which the relevant shelving-rail controller RC1-RC30 is attached. This input is received by PDA 7 and translated into shelf-level data RED, which represents the respective defined shelf level E1 to E5 and transmitted to the server 5 together with the respective identification data ID of the queried controller RC1-RC30.

This process is indicated in FIGS. 1 and 2 by positioning the PDA 7 near the twentieth shelving-rail controller RC20 and can be repeated for all shelving-rail controllers RC1-RC30.

In the case of the server 5, the previously determined coordinate pair KP is supplemented for the respective shelving-rail controller RC1-RC30 by the shelf level E1, E2, E3, E4 or E5 recorded for the respective shelving-rail controller RC1-RC30 using the unique identification data ID, which defines the relationship to the respective shelving-rail controller RC1-RC30, thereby finalizing the three-dimensional location.

For example, the spatial location coordinates for the shelving-rail controllers RC1-RC30 are as follows:
RC1 as three-dimensional coordinates (X1, Y1, E1),
RC2 as three-dimensional coordinates (X2, Y1, E1),
. . .
RC15 as three-dimensional coordinates (X3, Y2, E3)
. . .
RC30 as three-dimensional coordinates (X6, Y3, E5).

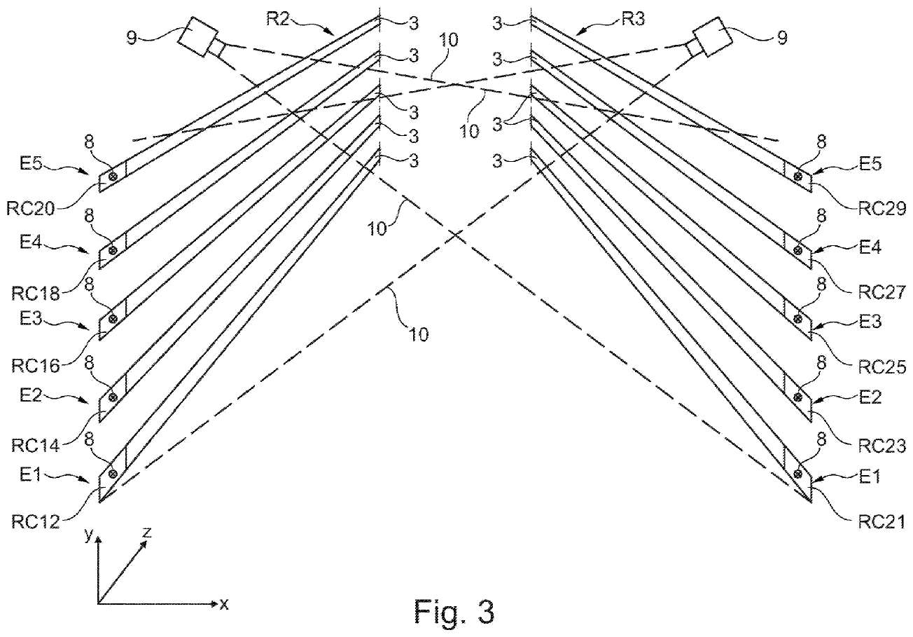

FIG. 3 perspectively shows a path between the two shelves R2 and R3 for illustrating a second exemplary embodiment regarding the structure of the data structure, wherein the illustration of shelves R2 and R3 has been reduced to shelving rails 3.

In accordance with this second exemplary embodiment, the data structure was set up fully automatically. For this purpose, each shelving-rail controller RC1-RC30 is equipped with an LED 8 (LED stands for Light-Emitting Diode) and is designed in such a way that it emits its identification data ID optically coded as a flashing signal with the aid of LED 8 due to a control command of server 5. A camera 9, which films the relevant shelf R2, R3 from diagonally above the relevant shelf R2, R3, captures the flashing sequences of the LEDs 8 together with the shelving rails 3, which are arranged in the shelf levels E1-E5. The detection areas of the two cameras 9 are indicated with broken lines 10. These digital images are transmitted by radio, e.g., via the WLAN network or wired via a LAN network, to the server 5 and subjected to a software-based, fully automatic image or video evaluation, from which the data structure is obtained from which the supplementary data is automatically taken or obtained to supplement the third coordinate. Of course, this fully automatic evaluation of the images does not require a static data structure to be set up in order to be able to obtain the supplementary data from there only after they have been created. Rather, the respective data set of the supplementary data, as soon as it has been created, can be used “on the fly,” so to speak, to supplement the third coordinate.

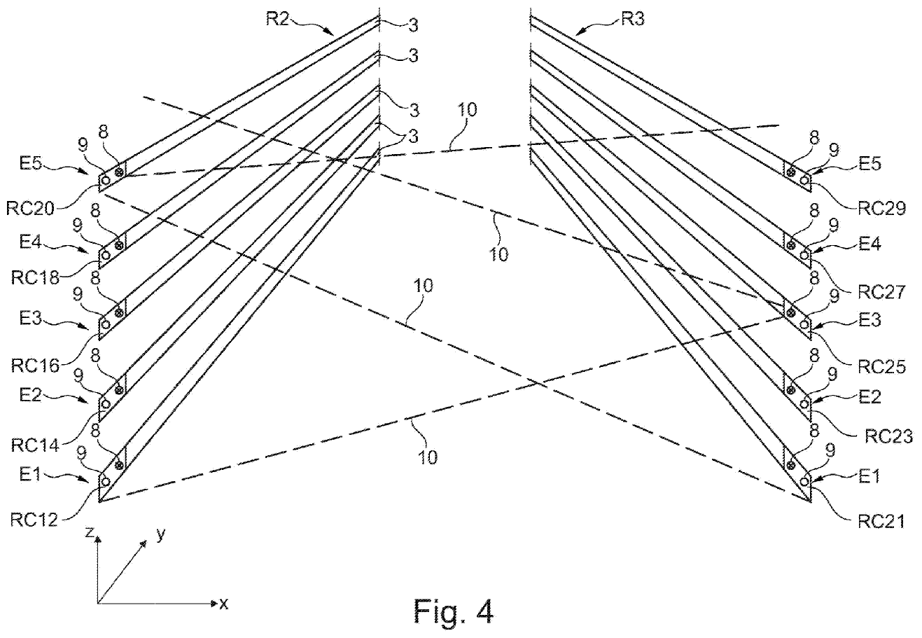

In analogy to FIG. 3, the path between the two shelves R2 and R3 is shown in perspective in FIG. 4 for the discussion of a third exemplary embodiment regarding the structure of the data structure, wherein the illustration of the shelves R2 and R3 has also been reduced to the shelving rails 3.

In accordance with this third exemplary embodiment, the data structure was also set up fully automatically. In the present case, in addition to the LED 8, the shelving-rail controllers also each comprise the camera 9, but in a power-saving and miniaturized embodiment. The cameras 9, which positioned on opposite sides of the path, capture or film the opposite shelf front, including the shelving rails 3, on which the shelving-rail controllers emitting their identification data ID by flashing signals are positioned in accordance with the control via the server 5. As previously discussed, the digital images obtained in this way are transmitted to the server 5 and evaluated there in order to generate the supplementary data and thus determine the third coordinate.

The RC1-RC30 shelving-rail controllers, which are now located with high precision, form the basis for furthermore system functions.

This includes the inclusion of other shelving-rail objects that are attached to the shelving rail of the respective shelving-rail controller RC1-RC30 in the localization in order to also make these shelving-rail objects accessible to a planogram as well. These shelving-rail objects can also include simple paper or plastic labels that do not require any electronics. They can be logically assigned to one of the shelving-rail controllers via the respective product information contained on their surface. However, these shelving-rail objects also include electronic devices, i.e., the shelving-rail clients, which make their electronic functions accessible to the system or server 5 via the respective shelving-rail controller RC1-RC30. For their precise location, the knowledge of which of the shelving rails 3 they are mounted on can be used, which is now clearly assigned to one of the shelving-rail controllers RC1-RC10, wherein, of course, the respective shelving-rail clients are also logically assigned to a single shelving-rail controller RC1-RC30, which is referred to as “binding” in technical jargon. As discussed, this can be done by capturing images and evaluating either their characteristic appearance or their screen content. In this way, even their position along the respective shelving rail can be precisely detected and determined. If the shelving-rail clients are also equipped with their own LED for emitting a flashing signal, it is only necessary to search for the respective flashing shelving-rail client in the captured images or videos of the cameras and to assign it to the relevant shelving rail 3 in order to determine the three-dimensional location of the relevant shelving-rail client. If the shelving-rail clients are also designed to signal their own identification data, their identification can also be carried out together with their location determination by evaluating the images or videos captured with the aid of a camera.

However, shelving-rail controllers RC1-RC30 located with high precision can also be used for high-precision object localization or tracking. In contrast to a few UWB-radio devices distributed on the ceiling of shop 1, the shelves R1-R3 themselves with their RC1-RC30 shelving-rail controllers installed there are now the anchor points for object localization or, in a dynamic sense, for object tracking. Due to their location directly in the shelves R1-R3, which form the “side walls” of shelf paths, they allow a much more precise location of an object that is moved along the paths equipped with a UWB-radio device. The transmitting power for UWB-radio communication can also be reduced accordingly because the stationary UWB-radio device is always in the immediate vicinity of the fixed and locally known UWB-radio modules of the RC1-RC30 shelving-rail controllers located on the “side walls”. This contributes to the energy-efficient use of this technology. In addition, for the purpose of determining the location of the moveable UWB-radio device, even only one group (e.g., only 1-10 pieces in the immediate vicinity of the object) of shelving-rail controllers RC1-RC30 that are more or less directly adjacent to the object can be used. This group of RC1-RC30 shelving-rail controllers active for the purpose of locating and tracking the UWB-radio device can be dynamically adapted to the respective location of the mobile UWB-radio device or its relocation. The active sub-group of shelving-rail controllers RC1-RC30 used to locate the object is therefore continuously adapted to the movement of the object and “follows” the object or “accompanies” the object through the shop. Other shelving-rail controllers RC1-RC30 that are positioned further away from the object to be tracked and are therefore, shelving-rail controllers RC1-RC30 that not required for the location of the object can be disabled. This furthermore reduces the energy requirements of the system, particularly to the absolute necessary level for the purposes of tracking the location of the moving object. The moveable object, which also comprises a UWB-radio device, can be, for example, a PDA of an employee of shop 1 or a customer, or it can also be integrated into a mobile phone of the customer. Such a UWB-radio device can also be integrated into the electronics of a (smart) shopping trolley. These measures can be used for high-precision indoor navigation in business premises.

What all these measures have in common is that they are applied under the controlling control of a higher-level administration instance, such as server 5 or the cloud-based management software. This means that the respective administration instance initiates the discussed localization measures through computerized control of the respective system components or controls the implementation of the localization measures.

It should also be noted that the above-mentioned shelving-rail controllers, as well as the shelving-rail clients or the electronic devices in general, comprise electronics with the aid of which, where applicable, by executing software, the different functions are implemented. The electronics can be discrete or constructed by integrated electronics, or also a combination of both. Microcomputers, micro-controllers, Application Specific Integrated Circuits (ASICs), possibly in combination with analogue or digital electronic peripherals, can also be used.

Furthermore, it should be mentioned that the shelf arrangement shown in FIGS. 1-4 was, of course, only configured in such a straightforward way for explanatory purposes. The measures discussed can also be applied to much more complex arrangements of shelves and shelving rails without inventive action, particularly also applied to configurations in which a plurality of shelves as well as shelving rails are strung together.

Finally, it is pointed out once again that the figures described in detail above are only exemplary embodiments, which can be modified by the person skilled in the art in various ways without leaving the field of the invention. For the sake of completeness, it is also pointed out that the use of the indefinite article “a” does not exclude that the respective features can also be present a multiple of times.

1. Method for locating shelving-rail equipment (RC1-RC30) positioned on a shelving rail (3) at an unknown location, wherein the method comprises the following method steps, namely:
automatic determination of a location of the shelving-rail equipment (RC1-RC30) on a level by means of radio communication between the shelving-rail equipment (RC1-RC30) and locally known radio devices (4; 6) and
automatic addition of a third coordinate to the location on the level in order to determine the spatial location of the shelving-rail equipment (RC1-RC30) by using supplementary data, wherein the supplementary data represent the third coordinate and are related to the shelving-rail equipment (RC1-RC30).

2. Method according to claim 1, wherein ultra-wideband-radio communication between locally known ultra-wideband-radio devices (6), in particular, access points equipped with them, each positioned at different known locations at a distance from the shelving-rail equipment (RC1-RC30), and the shelving-rail equipment (RC1-RC30) is used for the automatic determination of the location on the level.

3. Method according to claim 1, wherein the supplementary data is obtained from a data structure stored in an electronic database and the data structure indicates at which shelf level (E1-E5) of a shelf (R1-R3) the relevant shelving equipment (RC1-RC30) is installed as the third coordinate.

4. The method according to claim 3, wherein the data structure is constructed by capturing identification data of the shelving-rail equipment (RC1-RC30) and assigning the identification data to the shelf level (E1-E5) where the shelving-rail equipment (RC1-RC30) is located.

5. Method according to claim 4, wherein for the purpose of assigning the identification data to the appropriate shelf level (E1-E5) by means of a portable recording device (7), the identification data is automatically read out by the shelving-rail equipment (Rc1-RC30) and shelf-level data is generated by receiving an input to determine the shelf level (E1-E5) at the recording device (7) and the identification data together with the shelf-level data is sent to the electronic database, preferably with the aid of radio communication, transmitted and stored there.

6. Method according to claim 4, wherein for the purpose of assigning the identification data to the applicable shelf level (E1-E5), the shelving-rail equipment (RC1-RC30) emits an optically perceptible or machine-processable first signal and, with the aid of a camera (9), a digital image of the shelf (R1-R3) is created on which the relevant shelving-rail equipment (RC1-RC30) is located, and computerizes in the digital image by detecting the optical signal that shelf level (E1-E5), on which the shelving-rail equipment (RC1-RC30) is located, which emits the optical signal, and the shelf-level data generated from it is transmitted to the electronic database, preferably by means of radio communication, and stored there.

7. Method according to claim 6, wherein the shelving-rail equipment (RC1-RC30) emits its identification data with the aid of the optically perceptible or machine-processable first signal and the identification data are computationally extracted from the digital image and transmitted together with the shelf-level data.

8. Method according to claim 6, wherein the camera (9) is installed on a shelving rail (3) of a first shelf (R1-R3) and the camera (9) detects a second shelf (R1-R3) across a shelf path on which the shelving-rail equipment (RC1-RC30) is installed, which emits the optically perceptible or machine-processable signal.

9. Method according to claim 1, wherein the shelving-rail equipment (RC1-RC30) is a shelving-rail controller which supplies electrical power, preferably also communication, to at least one shelving-rail client installed on its shelving rail (3), and the location of the shelving-rail controller is used to narrow down the location of the shelving-rail clients to the known extent of the shelving rail (3).

10. The method according to claim 9, wherein a digital image of the relevant shelving rail (3) is created by means of a camera (9) and the location of the shelving-rail client (RC1-RC30) along the relevant shelving rail (3) is determined by computerized image evaluation.

11. Method according to claim 10, wherein the shelving-rail client emits its identification data by means of an optically perceptible or machine-processable second signal emitted by it and, in the computerized image evaluation, the identification data is extracted and the location of the relevant shelving-rail client along the shelving rail (3) is determined.

12. Method according to claim 1, wherein the shelving-rail equipment (RC1-RC30), in particular, implemented as shelving-rail controllers, is designed to emit beacons.
